(19) United States
(12) Patent Application Publication
(10) Pub. No.: US 2005/0041110 A1
(43) Pub. Date: Feb. 24, 2005

(54) Digital camera user interface and method

(76) Inventor: Frank Liebenow, Dakota Dunes, SD (US)

Correspondence Address: GATEWAY, INC.;ATTN: SCOTT CHARLES RICHARDSON, 610 GATEWAY DRIVE, MAIL DROP Y-04, N. SIOUX CITY, SD, 57049, US

(21) Appl. No.: 10/646,261

(22) Filed: Aug. 21, 2003

(51) Int. Cl. H04N 5/225

(52) U.S. Cl. 348/207.99

(57) ABSTRACT

A user interface of a digital camera permits the user to set the camera to a setting that represents what they want to do with the resulting image, rather than all of the parameters that are necessary to produce the image. Each of a set of aliases, shortcuts, vectors, or the like represent a set of parameter settings. The shortcuts are assigned names which are related to the final use of the image produced with that parameter set, that is, a name the user can understand. For example, these settings' names may be “email”, “up to 4×6”, “up to 5×7”, “up to 8×10”, or “best quality possible.” With these settings, if the user is taking pictures to email or view on a PC, then a lower resolution and compression parameter can be used. If the user wants to make 8×10 prints, they select that shortcut and the camera adjusts resolution and compression to deliver images that will produce good 8×10 prints.

### BACKGROUND OF THE INVENTION

1. Field of the Invention

The present invention relates to devices, systems, and processes useful for producing digital images, and more particularly to providing a user-friendly interface for a digital camera.

2. Brief Description of the Related Art

Camera technologies have been enhanced by the incorporation of digital processors, e.g., computer processors on chips, in-camera memories, electronic displays, and a wide variety of features enabled by these technologies. While first introduced in analog, 35 mm cameras, digital cameras have expanded on the use of these computer technologies. Because digital cameras transform the light waves passing through the camera's lens into a digital data set, thereby bypassing the analog-to-digital conversion process previously required to digitize a photograph, digital cameras can provide a great deal of flexibility and convenience. Despite these advantages, there are new difficulties that digital cameras have created.

Operating a digital camera can be quite complex. There are typically settings for several operating parameters that must be established. While some digital cameras presume a default setting for some parameters, there are occasions when the user wishes to override these settings. For example, the number of pixels that the camera assigns for a particular image (e.g., 640×480, 1122×820, etc.) and the level or quality of compression (e.g., ‘super fine’, ‘fine’, ‘normal’, etc.) are two parameters that greatly effect the image quality and the memory required to store the image. Recognizing that the camera's user may wish to take photographs, i.e., store images in the camera's memory, at different sizes and data compression levels, digital cameras typically permit the user to select one of several levels for each of these parameters. For example, having three pixel settings and at least three compression levels settings requires the user to select a single mode of operation out of at least nine possible modes. This is a cumbersome, and at times confusing, task, and many users understand neither the reason for these settings nor the interplay between them.

The result can be a frustrating experience with the digital camera for the casual user. While some users may wish to save all image data with exactly the same set of operational parameters, there are times when the user may want to differentiate among some images based on what the camera user will do with the image. For example, the user may want one image, a portrait or landscape, to be printed on high-quality, large format paper, and therefore likely would want a very high number of pixels and a minimum of data loss through compression. The user's next image, for example a snapshot at a family picnic, may be intended for email distribution and computer viewing only, and therefore the user likely would prefer a lower pixel count and will accept higher data losses through higher compression.

A problem with current digital cameras is that the user must navigate through a complex series of menus and options to select parameters for each image, and then repeat this process for the next image parameter set. In addition to being quite cumbersome and time-consuming, some users will not fully appreciate the effect(s) of their choices, ultimately increasing the user's frustration with the results of their efforts on the stored image.

Both analog and digital cameras have been proposed that include menu systems and multiple program modes. Fully automatic modes, aperture priority modes, speed priority modes, auto-focusing algorithms, light detection and exposure controls, and other more complex functions have been proposed, with varying degrees of success and market penetration. While these features have expanded some uses of the cameras, none of them have focused on the ultimate use of the image by the user.

There remains a need for a digital camera user interface that lets the user indicate what they want to use the image for, and which sets camera operational parameters, e.g., the resolution and compression, accordingly. For the novice and/or hurried user, this type of setting would make picture taking much simpler.

### SUMMARY OF THE INVENTION

In a first aspect of the invention, a method of capturing a digital image comprises providing more than one format selection to be used in capturing the digital image, each format selection corresponding to a unique set of parameters for the capture of the digital image; selecting one format selection; and retrieving a set of parameters associated with the format selection.

In another aspect of the present invention, a digital camera user interface comprises means for assigning at least one shortcut to a unique set of operational parameters of the digital camera, and means for permitting a user to select the at least one shortcut.

In yet another aspect of the present invention, a digital camera user interface comprises logic configured to assign at least one shortcut to a unique set of operational parameters of the digital camera; and logic configured to permit a user to select the at least one shortcut.

Still other aspects, features, and attendant advantages of the present invention will become apparent to those skilled in the art from a reading of the following detailed description of embodiments constructed in accordance therewith, taken in conjunction with the accompanying drawings.

### BRIEF DESCRIPTION OF THE DRAWINGS

The invention of the present application will now be described in more detail with reference to preferred embodiments of the apparatus and method, given only by way of example, and with reference to the accompanying drawings, in which:

FIG. 1 schematically illustrates an exemplary system in accordance with the present invention.

FIG. 2 schematically illustrates a simplified view of a digital camera in accordance with an exemplary embodiment of the present invention.

FIG. 3 schematically illustrates an exemplary table of settings in accordance with the present invention.

### DESCRIPTION OF THE PREFERRED EMBODIMENTS

In general terms, one aspect of the present invention is a user interface of a digital camera that permits the user to set the camera to a setting that represents what they want to do with the resulting image, rather than all of the parameters that are necessary to produce the image. According to the present invention, each of a set of aliases, shortcuts, vectors, or the like represent a set of parameter settings. The shortcuts can be assigned names which are related to the final use of the image produced with that parameter set, that is, a name the user can understand. For example, these settings' names may be “email”, “up to 4×6”, “up to 5×7”, “up to 8×10”, or “best quality possible.” With these settings, if the user is taking pictures to email to someone or just have on the PC for viewing, then a lower resolution and compression parameter can be used. If the user wants to make 8×10 prints, they select that shortcut and the camera adjusts resolution, and compression, and optionally additional parameters to deliver images that will produce good 8×10 prints.

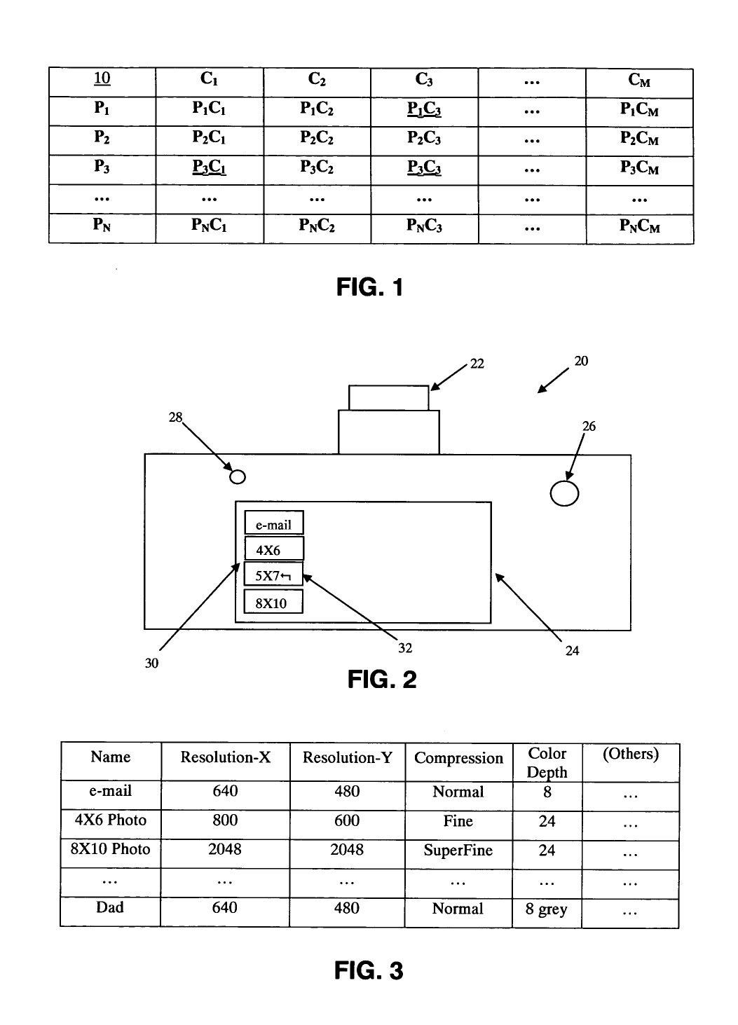

Turning now to the drawing Figures, an exemplary embodiment of a parameter array 10 is illustrated In FIG. 1. Those of ordinary skill in the art are well acquainted with the function and operation of digital cameras, and in particular the executable instruction sets that are operated on by the central processing unit of the camera. Accordingly, knowledge of the structure of a digital camera and the software that operates in a digital camera are presumed herein, so that aspects of the present invention are not obscured.

The array 10 is schematically illustrated as being an N×M array, which represents a preferred embodiment of the present invention with total resolution pixel settings P₁ through P_{N}, and data compression settings C₁, through C_{N}. The present invention is not limited to two operational parameters, and thus is not limited to an N×M array, and includes any number of parameters that can be set for an image taken on a digital camera. By way of example and not of limitation, the set of operational parameters includes, but is not limited to: resolution pixels for height (H); resolution pixels for width (W); color depth (e.g., bits per pixel); stereoscopic toggle (2D/3D); black/white-color toggle; and black/white greyscale level. Other operational parameters that can be used in the array 10 will be readily apparent to those of skill in the art and are included within the scope of the present invention.

Because visualization of an array with more than 3 parameters presents some difficulties, it is useful to consider each cell in the array as represented by a vector S, e.g., (Pᵢ, Cⱼ, . . . , X_{y}), wherein i, j, . . . , y, are counters for each of the parameters P, C, . . . , X, respectively, and in which X represents additional parameters. The permutations of all of the parameters result in a large number of vectors S, while a small number of these vectors are of interest to the user as shortcuts to particular sets of parameters. More particularly, according to the present invention, a limited number of the vector representations of all of the permutations of parameters are assigned a shortcut in the logic of the user interface of the digital camera, and are presented in the user interface with a useful and unique name, icon, or both. Optionally, the logic of the user interface can further include the function of adding user-defined vectors, and permits the user to assign names to these vectors using the user controls of the digital camera. Optionally, the logic of the digital camera includes logic to permit the user to change the settings for each predefined shortcut between a default set and different settings, i.e., the settings associated with any one predefined vector can be changed as well. Further optionally, the logic of the digital camera can include a novice/advanced toggle for the purpose of giving the user complete access to the entire array of parameters (advanced setting) or only the vector subset of preassigned vectors with useful names (novice setting). Other levels of such settings are also within the scope of the invention.

FIG. 1 schematically illustrates three exemplary array cells that are of interest for the novice user, the vector addresses of which are underlined. In the example illustrated in the Figure, the rows represent different values of the total number of pixels, while the columns represent different compression levels. By way of example and not of limitation, address P₁C₃ can be assigned the shortcut “email”, the address P₃C₁ the shortcut “up to 5×7”, and the address P3C3 the shortcut “best quality possible”. As discussed above, other parameters can be part of the array, resulting in each vector having more components; however, an aspect of the invention, that shortcuts to vectors of particular interest to the user are presented to the user by the camera's logic, underlies these additional embodiments as well.

FIG. 2 illustrates a simplified view of a digital camera 20 in accordance with an exemplary embodiment of the present invention. The camera 20 includes a lens 22, a user interface 24 that is driven by the logic of the camera, and a shutter control 26. A number of shortcuts 30 to sets of operational parameters for the camera 20 are displayed to the user on the interface 24, including the shortcut to the currently active operational parameter set 32. While numerous user controls can be provided to for the user to interact with the logic of the camera, a simple ‘next settings selector’ 28 can be provided for moving through, e.g., a menu of the shortcuts that have been defined. Other controls can be provided, as well know to those of skill in the art.

When the user selects one of the shortcuts presented to the user by the camera's logic through the user interface, the camera's logic changes the settings in the camera according to the parameter settings of the vector associated with the shortcut. Thereafter, when the user manipulates the camera's input controls (e.g., ‘shutter control’ or ‘release’ 26) to instruct the camera's logic to take a picture according to the format defined by the set of parameters, these parameter settings are used, and the resulting image data is stored according to user's selection. If the user wants to use a different set of parameters for the next image, the user needs to merely select a different shortcut, and take the picture. Of course, for the advanced user, the menu of shortcuts can be deselected using an appropriate toggle presented to the user by the camera's logic, so the advanced user can select the value for each parameter individually. As well known to those of skill in the art, the number of pixels of an image is typically represented by H×W (height by width, each in pixels), while compression levels are assigned more colloquial terms (‘super fine’, ‘fine’, ‘normal’), and the user interface of the present invention presents these parameters' levels' names to the user. Of course, other representations are also within the scope of the present invention.

FIG. 3 illustrates an example of a table of aliases and their associated parameters. One aspect of the present invention is that the digital camera 20 includes at least one, and preferably several predefined aliases, e.g., “e-mail”, “4×6 Photo”, “8×10 Photo”, with their associated operational parameters of Resolution-X, Resolution-Y, Compression level, Color Depth, as well as other parameters as described herein, set at default values. Although less preferable, it is also an aspect of the present invention that the camera 20 not include any predefined aliases. Yet another aspect of the present invention is that the logic of the camera 20 includes logic which permits the user to add new aliases to the set of aliases available to the user to select, and/or to modify the value(s) of a set of parameters of one or more existing aliases. Thus, for example, the logic of the camera 20 permits a user to add an alias named “Dad”, and to set the individual operational parameters associated with “Dad” to one of the available settings, e.g., Resolution-X=640, Resolution-Y=480, Compression level=Normal, and Color Depth=8 bit greyscale. Further optionally, when a new alias is created, predefined (or user-defined) default values are assigned to the parameters for the new alias. If the user later wants to change the settings for “Dad” or any other alias, the logic of the camera 20 permits the user to delete the entire alias, or modify any of the individual parameter settings associated with “Dad”.

While the invention has been described in detail with reference to preferred embodiments thereof, it will be apparent to one skilled in the art that various changes can be made, and equivalents employed, without departing from the scope of the invention. Each of the aforementioned documents is incorporated by reference herein in its entirety.

1. A method of configuring a digital camera capable of capturing an image, the method comprising:
providing more than one format selection to be used in capturing the digital image, each format selection corresponding to a unique set of parameters for the capture of the digital image;
selecting one format selection; and
retrieving a set of parameters associated with the format selection.

2. A method in accordance with claim 1, further comprising:
setting the operational parameters of the camera to the retrieved set of parameters.

3. A method in accordance with claim 2, further comprising:
capturing the digital image using said set of parameters.

4. A method in accordance with claim 1, wherein the set of parameters comprises resolution and compression level.

5. A method in accordance with claim 4, wherein providing comprises providing at least two format selections, the set of parameters of a first format selection including a higher resolution setting than that of the set of parameters of a second format selection.

6. A method in accordance with claim 4, wherein providing comprises providing at least two format selections, the set of parameters of a first format selection including a higher compression setting than that of the set of parameters of a second format selection.

7. A method in accordance with claim 1, wherein at least one parameter of the set of parameters is selected from the group consisting of height resolution, width resolution, total resolution, compression level, color depth, stereoscopic toggle, black/white-color toggle, black/white greyscale level, and combinations thereof.

8. A method in accordance with claim 1, wherein the set of parameters consists of resolution and compression level.

9. A method in accordance with claim 1, further comprising:
assigning a unique name to each of the format selections.

10. A method in accordance with claim 1, further comprising:
assigning a unique icon to each of the format selections.

11. A method in accordance with claim 1, further comprising:
assigning the parameters associated with a format selection to default values.

12. A method in accordance with claim 1, further comprising:
modifying at least one parameter of a set of parameters associated with a format selection.

13. A method in accordance with claim 1, further comprising:
generating a new format selection including an associated set of parameters.

14. A digital camera user interface comprising:
means for assigning at least one shortcut to a unique set of operational parameters of the digital camera; and
means for permitting a user to select the at least one shortcut.

15. A user interface in accordance with claim 14, wherein the operational parameters comprise resolution and compression level.

16. A user interface in accordance with claim 15, wherein the at least one shortcut comprises at least two shortcuts, the set of parameters of a first shortcut including a higher resolution setting than that of the set of parameters of a second shortcut.

17. A user interface in accordance with claim 15, wherein the at least one shortcut comprises at least two shortcuts, the set of parameters of a first shortcut including a higher compression setting than that of the set of parameters of a second shortcut.

18. A user interface in accordance with claim 14, further comprising:
means for changing at least one parameter of a set of parameters of at least one shortcut.

19. A user interface in accordance with claim 14, further comprising:
means for changing the settings of the digital camera to include the set of operational parameters.

20. A user interface in accordance with claim 14, wherein the means for permitting further comprises:
means for bypassing the at least one shortcut; and
means for permitting a user to directly select camera operational parameters.

21. A user interface in accordance with claim 14, further comprising:
means for adding a new shortcut and assigning operational parameters to said new shortcut.

22. A user interface in accordance with claim 21, wherein the means for assigning operational parameters to said new shortcut comprises means for assigning default values for said operational parameters.

23. A user interface in accordance with claim 14, further comprising means for assigning the parameters associated with a shortcut to default values.

24. A user interface in accordance with claim 14, wherein at least one parameter of the set of parameters is selected from the group consisting of height resolution, width resolution, total resolution, compression level, color depth, stereoscopic toggle, black/white-color toggle, black/white greyscale level, and combinations thereof.

25. A digital camera user interface comprising:
logic configured to assign at least one shortcut to a unique set of operational parameters of the digital camera; and
logic configured to permit a user to select the at least one shortcut.

26. A user interface in accordance with claim 25, wherein the operational parameters comprise resolution and compression level.

27. A user interface in accordance with claim 26, wherein the at least one shortcut comprises at least two shortcuts, the set of parameters of a first shortcut including a higher resolution setting than that of the set of parameters of a second shortcut.

28. A user interface in accordance with claim 26, wherein the at least one shortcut comprises at least two shortcuts, the set of parameters of a first shortcut including a higher compression setting than that of the set of parameters of a second shortcut.

29. A user interface in accordance with claim 25, further comprising:
logic configured to change at least one parameter of a set of parameters of at least one shortcut.

30. A user interface in accordance with claim 29, further comprising:
logic configured to change the settings of the digital camera to include the set of operational parameters.

31. A user interface in accordance with claim 25, wherein the logic configured to permit further comprises:
logic configured to bypass the at least one shortcut; and
logic configured to permit a user to directly select camera operational parameters.

32. A user interface in accordance with claim 25, further comprising:
logic configured to add a new shortcut and assign operational parameters to said new shortcut.

33. A user interface in accordance with claim 32, wherein the logic configured to assign operational parameters to said new shortcut comprises logic configured to assign default values for said operational parameters.

34. A user interface in accordance with claim 25, further comprising logic configured to assign the parameters associated with a shortcut to default values.

35. A user interface in accordance with claim 25, wherein at least one parameter of the set of parameters is selected from the group consisting of height resolution, width resolution, total resolution, compression level, color depth, stereoscopic toggle, black/white-color toggle, black/white greyscale level, and combinations thereof.
